(19) United States
(12) Patent Application Publication
(10) Pub. No.: US 2014/0274677 A1
(43) Pub. Date: Sep. 18, 2014

(54) System and Method for Optimized Oxygen Storage Capacity and Stability of OSM Without Rare Metals

(71) Applicant: Zahra Nazarpoor, Camarillo, CA (US)

(72) Inventor: Zahra Nazarpoor, Camarillo, CA (US)

(73) Assignee: CDTI, Ventura, CA (US)

(21) Appl. No.: 14/097,853

(22) Filed: Dec. 5, 2013

Related U.S. Application Data
(63) Continuation-in-part of application No. 13/849,169, filed on Mar. 22, 2013.
Application No. 13/849,169 is a continuation-in-part of application No. 13/849,230, filed on Mar. 22, 2013.
(60) Provisional application No. 61/791,721, filed on Mar. 15, 2013.
(60) Provisional application No. 61/791,838, filed on Mar. 15, 2013.

(51) Int. Cl. B01J 23/889

(52) U.S. Cl. CPC B01J 23/8892
USPC 502/324; 423/599

(57) ABSTRACT

It is an object of the present disclosure, to provide an oxygen storage material which may include optimum composition and structure of Cu—Mn spinel as OSM, with a suitable doped zirconia, including Niobium-Zirconia support oxide for OSM applications, which may include a chemical composition substantially free from rare metals. The OSC properties of Cu—Mn spinel with a suitable doped zirconia, including Niobium-Zirconia support oxide as OSM may be determined by comparing variations of Cu—Mn composition for determination of the optimum structure of spinel to achieve optimal OSC properties and thermal stability, which may be particularly useful for treating exhaust gases produced by internal combustion engines, where lean/rich fluctuations in operating conditions may produce high variation in exhaust contaminants that may be removed, achieving optimal OSC property of spinel at different temperatures, as well as thermal stability behavior of OSM.

### CROSS-REFERENCE TO RELATED APPLICATIONS

This application is a continuation-in-part of U.S. patent application Ser. Nos. 13/849,169 and 13/849,230, filed Mar. 22, 2013, respectively, and claims priority to U.S. Provisional Application Nos. 61/791,721 and 61/791,838, filed Mar. 15, 2013, respectively, and is related to U.S. patent application Ser. No. 14/090,861, filed Nov. 26, 2013, entitled System and Methods for Using Synergized PGM as a Three-Way Catalyst.

### BACKGROUND

1. Field of the Disclosure

The present disclosure relates generally to oxygen storage materials (OSM), and more particularly to optimized oxygen storage capacity and thermal stability of OSM without rare metals.

2. Background Information

Minimizing vehicle engine emissions are desirable to reduce environmental impacts as well as to comply with governmental mandates, such as regulations promulgated by the United States Environmental Protection Agency (EPA).

Some gasoline, or diesel fueled engines may be operated at higher than stoichiometric air-to-fuel mass ratios for improved fuel economy. The hot exhaust gas produced by such lean-burn engines generally includes a relatively high concentration of oxygen (about one to about ten percent by volume) and water, as well as unwanted gaseous emissions that may need to be converted to more innocuous substances before being discharged to the atmosphere.

OSM included in a catalyst system is needed for storing excess oxygen in an oxidizing atmosphere and releasing it in a reducing atmosphere. Through oxygen storage and release, a safeguard is obtained against fluctuations in exhaust gas composition during engine operation, enabling the system to maintain a stoichiometric atmosphere in which NOₓ, CO and HC can be converted efficiently. Ceria (CeO₂) was the first material used as OSM in catalyst systems because of its effective oxygen storage capacity (OSC) properties. Subsequently, a CeO₂—ZrO₂ solid solution replaced CeO₂ because of its improved OSC and thermal stability.

Accelerated OSM reaction and enhanced performance is desirable, which is particularly important for meeting increasingly stringent state and federal government vehicle emissions standards. Therefore, there is a continuing need to provide cost effective OSM that is free of rare metals and can provide sufficient oxygen storage capacity and thermal stability.

For the foregoing reasons, there is a need for oxygen storage materials capable to produce optimized OSC properties for TWC applications, employing a formulation substantially free of rare metal, which may be able to achieve similar or better performance than existing OSM containing large amount of rare metals used in catalyst systems.

### SUMMARY

The present disclosure may provide enhanced oxygen storage material (OSM) for optimized thermal stability properties, which may include a chemical composition substantially free from rare metals.

It is an object of the present disclosure to provide an oxygen storage material which may include Cu—Mn spinel as OSM and variations of Cu—Mn ratios with a suitable doped zirconia, including Niobium-Zirconia support oxide for OSM applications, where the material may be prepared using a suitable co-precipitation method, or any other preparation technique known in the art.

The OSC properties of the disclosed OSM, according to other embodiments in the present disclosure, may be determined using CO and O₂ pulses under isothermal oscillating condition, referred as OSC test, to determine O₂ and CO delay times, to compare performance of different Cu and Mn ratios.

According to another embodiment, an OSC test of fresh and aged samples of Cu—Mn spinel as OSM and variations of Cu—Mn ratios may be employed for determination of carbon balance, consumption of CO, and formation of CO₂ in the absence of O₂, which may be obtained during OSC isothermal oscillating test of OSM sample.

The OSC properties of Cu—Mn spinel with a suitable doped zirconia, including Niobium-Zirconia support oxide as OSM may be determined by comparing variations of Cu—Mn ratios for determination of the optimum composition of spinel formulation to achieve optimal OSC property.

The OSC properties of hydrothermally aged samples of disclosed OSM may be determined by comparing variations of Cu—Mn ratios at different temperatures, including but not limited to fresh, aging at 900° C., and aging at 1000° C. for determination of the optimum composition of spinel formulation to achieve optimal thermal stability.

The present disclosure may provide solutions for enhanced performance of TWC catalyst systems, employing Cu—Mn spinel as OSM with optimized composition, which may be particularly useful for treating exhaust gases produced by internal combustion engines, where lean/rich fluctuations in operating conditions may produce high variation in exhaust contaminants that may be removed, achieving enhanced stability during aging and optimal performance under any operating conditions.

Numerous other aspects, features, and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows OSC isothermal oscillating test results for fresh samples of the disclosed OSM of Example #1 at 575° C., according to an embodiment.

FIG. 2 depicts OSC isothermal oscillating test results for fresh samples of the disclosed OSM of Example #2 at 575° C., according to an embodiment.

FIG. 3 depicts a graph carbon balance obtained during OSC isothermal oscillating test of a fresh sample of the disclosed OSM of Example #2, according to an embodiment.

FIG. 4 shows variation of O₂ delay time with temperature of aging for disclosed OSM of Example #1, 2, and 3 at 575° C., according to an embodiment.

FIG. 5 depicts variation of CO delay time with temperature of aging for disclosed OSM of Example #1, 2, and 3 at 575° C., according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms may have the following definitions:

“Catalyst” refers to one or more materials that may be of use in the conversion of one or more other materials.

“Substrate” refers to any material of any shape or configuration that yields a sufficient surface area for depositing a washcoat and/or overcoat.

“Washcoat” refers to at least one coating including at least one oxide solid that may be deposited on a substrate.

“Milling” refers to the operation of breaking a solid material into a desired grain or particle size.

“Co-precipitation” may refer to the carrying down by a precipitate of substances normally soluble under the conditions employed.

“Calcination” refers to a thermal treatment process applied to solid materials, in presence of air, to bring about a thermal decomposition, phase transition, or removal of a volatile fraction at temperatures below the melting point of the solid materials.

“Rare metals” refers to chemical elements in the lanthanides group, scandium, and yttrium.

“Oxygen storage material (OSM)” refers to a material able to take up oxygen from oxygen rich streams and able to release oxygen to oxygen deficient streams.

“Oxygen storage capacity (OSC)” refers to the ability of materials used as OSM in catalysts to store oxygen at lean and to release it at rich condition.

“Conversion” refers to the chemical alteration of at least one material into one or more other materials.

“Adsorption” refers to the adhesion of atoms, ions, or molecules from a gas, liquid, or dissolved solid to a surface.

“Desorption” refers to the process whereby atoms, ions, or molecules from a gas, liquid, or dissolved solid are released from or through a surface.

“R value” refers to the number obtained by dividing the reducing potential by the oxidizing potential of materials in a catalyst.

“Rich condition” refers to exhaust gas condition with an R value above 1.

“Lean condition” refers to exhaust gas condition with an R value below 1.

“Air/Fuel ratio” or “A/F ratio” refers to the weight of air divided by the weight of fuel.

### DESCRIPTION OF THE DRAWINGS

The present disclosure may provide enhanced oxygen storage capacity with improved thermal stability properties, which may include a chemical composition substantially free from rare metals.

It is an object of the present disclosure to provide an oxygen storage material (OSM) which may include Cu—Mn spinel as OSM and variations of Cu—Mn ratios with a suitable doped zirconia, including Niobium-Zirconia support oxide for OSM applications, having an enhanced oxygen storage capacity and optimized thermal stability.

According to an embodiment, the disclosed Cu—Mn spinel as OSM with a suitable doped zirconia, including Nb₂O₅—ZrO2 support oxide may be applied as washcoat layer, employing a suitable cordierite ceramic substrate to measure OSC property and thermal stability. The subject OSM may be prepared using co-precipitation method or any other preparation technique known in the art.

OSM Material Composition and Preparation

The preparation of Cu—Mn spinel as OSM may begin by milling Nb₂O₅—ZrO₂ support oxide to make aqueous slurry. The Nb₂O₅—ZrO₂ support oxide may have Nb₂O₅ loadings of about 15% to about 30% by weight, preferably about 25% and ZrO₂ loadings of about 70% to about 85% by weight, preferably about 75%.

The Cu—Mn solution may be prepared by mixing an appropriate amount of Mn nitrate solution (MnNO₃) and Cu nitrate solution (CuNO₃), where the suitable copper loadings may include loadings in a range of about 10% to about 15% by weight. Suitable manganese loadings may include loadings in a range of about 15% to about 25% by weight. The next step is precipitation of Cu—Mn nitrate solution on Nb₂O₅—ZrO₂ support oxide aqueous slurry, which may have added thereto an appropriate base solution, such as in order to adjust the pH of the slurry to a suitable range. The precipitated slurry may be aged for a period of time of about 12 to 24 hours under continued stirring at room temperature.

According to principles in the present disclosure, Cu—Mn spinel as OSM may be used in WC layer for application on substrate, using a suitable cordierite material with honeycomb structure, where substrate may have a plurality of channels with suitable porosity. The OSM in form of aqueous slurry of Cu—Mn/Nb₂O₅—ZrO₂ may be deposited on the suitable substrate to form a washcoat employing vacuum dosing and coating systems. In the present disclosure, a plurality of capacities of WC loadings may be coated on suitable substrates. The plurality of WC loading may vary from about 60 g/L to about 200 g/L, in this disclosure particularly about 120 g/L. Subsequently, after deposition on substrate of the suitable loadings of Cu—Mn/Nb₂O₅—ZrO2 OSM slurry, the WC may be treated.

According to embodiments in the present disclosure, treatment of the WC may be enabled employing suitable drying and heating processes. A commercially available air knife drying systems may be employed for drying the WC. Heat treatments may be performed using commercially available firing (calcination) systems. The treatment may take from about 2 hours to about 6 hours, preferably about 4 hours, at a temperature within a range of about 550° C. to about 650° C., preferably at about 600° C.

A suitable OSM deposited on substrate may have a chemical composition with a total loading of about 120 g/L, including a Cu—Mn spinel structure with copper loading of about 10 g/L to about 15 g/L and manganese loading of about 20 g/L to about 25 g/L.

According to principles in the present disclosure, the disclosed composition of Cu—Mn spinel as OSM may be subjected to testing under isothermal oscillating condition to determine the O₂ and CO delay times and OSC properties at a selected temperature. A set of different O₂ and CO delay times may be obtained when a range of temperatures may be chosen to further characterize the OSC properties of the OSM material. In order to check the thermal stability of the disclosed Cu—Mn spinel as OSM, samples may be hydrothermally aged employing about 10% steam/air at about 900° C. and about 1000° C. for about 4 hours. Test results may be compared with a plurality of existing fresh samples.

According to principles in the present disclosure, in order to determine the optimal composition of Cu—Mn spinel, for optimum oxygen storage capacity, different testings may be performed for determination of O2 and CO delay time as representative of oxygen storage property of disclosed OSM systems. Fresh and aged disclosed OSM samples with different variations of Cu and Mn ratios may be evaluated in accordance with the following test procedures:

### Example #1

### Cu_{0.5}Mn_{2.5}O₄ Spinel with ZrO₂—Nb₂O₅Support Oxide as OSM

Preparation of EXAMPLE #1 as OSM may include samples of Cu—Mn spinel as described above using Cu_{0.5}Mn_{2.5}O₄ composition with ZrO₂—Nb₂O₅ support oxide, having a Cu loading 6.6 g/L, and Mn loading of 28.2 g/L. The total loading of WC is 120 g/L.

### Example #2

### Cu_{0.75}Mn_{2.25}O₄Spinel with ZrO₂—Nb₂O₅ Support Oxide as OSM

Preparation of EXAMPLE #2 as OSM may include samples of Cu—Mn spinel as described above using Cu_{0.75}Mn_{2.25}O₄ composition with ZrO₂—Nb₂O₅ support oxide, having a Cu loading of 9.8 g/L, and Mn loading of 25.4 g/L. The total loading of WC is 120 g/L.

### Example #3

### Cu_{1.0}Mn_{2.0}O₄ Spinel with ZrO₂—Nb₂O₅ Support Oxide as OSM

Preparation of EXAMPLE #3 as OSM may include samples of Cu—Mn spinel as described above using Cu_{1.0}Mn_{2.0}O₄ composition with ZrO₂—Nb₂O₅ support oxide, having a Cu loading of 13.0 g/L, Mn loading of 22.4 g/L. The total loading of WC is 120 g/L.

OSC Isothermal Oscillating Test Procedure

Testing of the OSC property of the disclosed Cu—Mn spinel as OSM with variations of Cu—Mn ratios various spinel compositions) may be performed under isothermal oscillating condition to determine O₂ and CO delay times, the time required to reach to 50% of the O₂ and CO concentration in feed signal. Testing may be performed for fresh and hydrothermally aged samples of the disclosed OSM samples to compare oxygen storage property of the disclosed OSM.

The OSC isothermal test may be carried out at temperature of about 575° C. with a feed of either O₂ with a concentration of about 4,000 ppm diluted in inert nitrogen (N₂), or CO with a concentration of about 8,000 ppm of CO diluted in inert N₂. The OSC isothermal oscillating test may be performed in a quartz reactor using a space velocity (SV) of 60,000 hr-1, ramping from room temperature to isothermal temperature of about 575° C. under dry N₂. At the temperature of about 575° C., OSC test may be initiated by flowing O₂ through the OSM samples in the reactor. After 2 minutes, the feed flow may be switched to CO to flow through the OSM samples in the reactor for another 2 minutes, enabling the isothermal oscillating condition between CO and O₂ flows during a total time of about 1,000 seconds. Additionally, O₂ and CO may be allowed to flow in the empty test reactor not including the disclosed OSM. Subsequently, testing may be performed allowing O₂ and CO to flow in the test tube reactor including fresh samples of the disclosed OSM and observe/measure the OSC property of the disclosed OSM. As the disclosed OSM may have OSC property, the OSM may store O₂ when O₂ flows. Subsequently, when CO may flow, there is no O₂ flowing, and the O₂ stored in the disclosed OSM may react with the CO to form CO₂. The time during which the OSM may store O₂ and the time during which CO may be oxidized to form CO₂ may be measured.

According to principles in the present disclosure, the OSC test may assist in analyzing/measuring an elemental carbon balance and illustrate what occurs during flowing of CO through the OSM samples, the desorption of O₂ which may be stored in the disclosed OSM, and the formation of CO₂ in absence of a O₂ stream.

OSC Property of Fresh OSM Samples

FIG. 1 shows OSC isothermal oscillating test 100 of fresh samples of Cu—Mn spinel of EXAMPLE #1 as OSM at 575° C., which may include samples of Cu_{0.5}Mn_{2.5}O₄ with ZrO₂—Nb₂O₅ support oxide.

The samples employed for the investigation described below may be prepared as per EXAMPLE #1 to determine CO and O2 delay time at temperature of about 575° C., according to an embodiment. In FIG. 1, curve 102 (double-dot dashed graph) shows the result of flowing 4,000 ppm O₂ through an empty test reactor which may be used for OSC isothermal oscillating test 100. Curve 104 (dashed graph) depicts the result of flowing 8,000 ppm CO through the empty test reactor, curve 106 (single-dot dashed graph) shows the result of flowing 4,000 ppm O₂ through the test reactor including the disclosed OSM, and curve 108 (solid line graph) depicts the result of flowing 8,000 ppm CO through the test reactor including the disclosed OSM.

It may be observed in FIG. 1 that the O₂ signal in presence of the disclosed Cu—Mn spinel as OSM, as shown in curve 106, does not reach the O₂ signal of empty reactor shown in curve 102. This result indicates the storage of a large amount of O₂ in the disclosed OSM samples. The measured O₂ delay time, which is the time required to reach to an O₂ concentration of 2,000 ppm (50% of feed signal) in presence of the OSM sample, is about 45.67 seconds. The O₂ delay time measured from OSC isothermal oscillating test 100 indicates that the disclosed OSM samples have significant OSC properties.

Similar result may be observed for CO. As may be seen, the CO signal in presence of disclosed OSC showed in curve 108 does not reach the CO signal of empty reactor shown in curve 104. This result indicates the consumption of a significant amount of CO by the disclosed OSM sample and desorption of stored O₂ for the conversion of CO to CO₂. The measured CO delay time, which is the time required to reach to a CO concentration of 4000 ppm in the presence of OSM sample is about 44.55 seconds. The CO delay time measured from OSC isothermal oscillating test 100 shows that the disclosed OSM samples have significant OSC properties.

The measured O₂ delay time and CO delay times may be an indication that the disclosed Cu—Mn spinel as OSM, substantially free from rare metals, may exhibit enhanced OSC as noted by the highly activated total and reversible oxygen adsorption and CO conversion that occurs under isothermal oscillating condition.

FIG. 2 shows OSC isothermal oscillating test 200 for fresh samples of Cu—Mn spinel of EXAMPLE #2 as OSM at 575° C., which may include samples of Cu_{0.75}Mn_{2.25}O₄ with ZrO₂—Nb₂O₅ support oxide.

The samples may be prepared as per of EXAMPLE #2 to determine CO and O2 delay time at temperature of about 575° C., according to an embodiment. In FIG. 2, curve 202 (double-dot dashed line) shows the result of flowing 4,000 ppm O₂ through an empty test reactor which may be used for OSC isothermal oscillating test 200; curve 204 (dashed line) depicts the result of flowing 8,000 ppm CO through the empty test reactor; curve 206 (single-dot dashed lines) shows the result of flowing 4,000 ppm O₂ through the test reactor including the disclosed OSM; and curve 208 (solid line graph) depicts the result of flowing 8,000 ppm CO through the test reactor including the disclosed OSM.

As may be seen in FIG. 2 the O₂ signal in presence of the disclosed Cu—Mn spinel as OSM, as shown in curve 206, does not reach the O₂ signal of empty reactor shown in curve 202. This result indicates the storage of a large amount of O₂ in the disclosed OSM samples. The measured O₂ delay time, which is the time required to reach to an O₂ concentration of 2,000 ppm (50% of feed signal) in presence of the OSM samples, is about 52.35 seconds. The O₂ delay time measured from OSC isothermal oscillating test 200 indicates that the disclosed OSM samples have a significant OSC property.

Similar result may be observed for CO. As may be seen, the CO signal in presence of disclosed OSM showed in curve 208 reach the CO signal of empty reactor shown in curve 204. This result indicates the consumption of a significant amount of CO by the disclosed OSM samples and desorption of stored O₂ for the conversion of CO to CO₂. The measured CO delay time, which is the time required to reach to a CO concentration of 4000 ppm in the presence of OSM samples is about 50.46 seconds. The CO delay time measured from OSC isothermal oscillating test 100 shows that the disclosed OSM samples have a significant OSC property.

Based on results of CO and O₂ delay time, the behavior of fresh OSM samples of EXAMPLE #2 substantially free from rare metals with spinel composition of Cu_{0.75}Mn_{2.25}O₄, may outperform the OSM samples of EXAMPLE #1 with spinel composition of Cu_{0.5}Mn_{2.5}O₄. The measured O₂ delay time and CO delay times may be an indication that the disclosed OSM, may exhibit enhanced OSC properties as noted in the highly activated total and reversible oxygen adsorption, and CO conversion that occurs under isothermal oscillating condition. Higher air/fuel ratio may provide high oxygen storage capacities, increasing the OSC efficiency, by supplying required oxygen to rich exhaust and taking up oxygen from lean exhaust, thus buffering the catalyst system against fluctuating supply of oxygen, optimizing the OSC.

FIG. 3 depicts a graph of OSC carbon balance 300 which may be obtained from fresh samples of Cu—Mn spinel as OSM in EXAMPLE #2 for isothermal OSC test at temperature of about 575° C., employing Cu_{0.75}Mn_{2.25}O₄ composition with ZrO₂—Nb₂O₅ support oxide. The OSC carbon balance 300 may illustrate what occurs during flowing of CO on the OSM samples and desorption of stored O₂ for the conversion of CO to CO₂.

As may be seen in FIG. 3, curve 302 (dot lines) shows the concentration of carbon element in the empty test reactor during flowing of the CO feed and curve 306 (solid line graph) shows the concentration of carbon element in the OSM sample in the test reactor during flowing of the CO feed. Additionally, curve 304 (dashed line) depicts the concentration of CO passing through fresh sample of the disclosed OSM in reactor and curve 308 (double dot dashed line) shows the concentration CO₂ formed in the reactor including fresh sample of the disclosed OSM in reactor.

In FIG. 3 may be observed the formation of CO₂ (curve 308) indicates oxidation of CO and desorption of stored O₂ during flowing of the CO feed. The O₂ required for formation of CO₂ is supplied by the O₂ already stored in the disclosed OSM sample. The storage of O₂ under lean condition, when the O₂ feed is flowing, and releasing of O₂ under rich condition, when the CO feed is flowing, confirm the OSC property of disclosed OSM sample.

The OSC of carbon balance shows consumption of CO and formation of CO₂ in the absence of O₂ because the O₂ required for reaction is provided by stored oxygen in material. The resulting OSC properties obtained from fresh samples of the disclosed OSM, are indicative of an optimized OSC property of disclosed OSM sample.

Thermal Stability of Disclosed OSM Free of Rare Earth Metals

According to principles in the present disclosure, the isothermal oscillating OSC test for O₂ and CO delay time determination which has been done for fresh disclosed OSM compare to O₂ and CO delay time determination of disclosed OSM after aging at different temperatures may illustrate the thermal stability disclosed OSM free of rare earth metals.

The chemical composition to achieve optimal OSC properties and thermal stability, employing Cu—Mn spinel with Niobium-Zirconia support oxide as OSM, may be determined by comparing variations of Cu—Mn ratio “x” on CuₓMn₃₋ₓO₄ spinel formulation at different temperatures, including but not limited to fresh, aging at 900° C., and aging at about 1000° C.

FIG. 4 illustrates test results O2 delay time 400 for variation of O₂ delay time for disclosed OSM samples without rare metals prepared per Example #1 to Example #3 with different spinel compositions, to perform isothermal oscillating OSC test at temperature of about 575° C. Aged samples have been prepared by hydrothermal aging with 10% steam at about 900° C. for about 4 hours, and by hydrothermal aging with 10% steam at about 1000° C. for about 4 hours.

In FIG. 4, each of the data points represents variations of “x” in CuₓMn₃₋ₓO₄ spinel formulation employing stoichiometric and non-stoichiometric spinel deposited on Nb₂O₅—ZrO₂ support oxide without rare metals. Fresh and hydrothermally aged samples may be employed to measure oxygen delay time in seconds according to temperature, including but not limited to fresh, and hydrothermal aging at 900° C., and aging at 1000° C., identified with data points as follows:

For spinel composition of x=1.0 data point 402 (dot and dash lines), for x=0.75 data point 404 (dash lines), and for x=0.5 data point 406 (solid lines). Each of the data points represents the measured O₂ delay time in seconds based on the isothermal OSC test performed at 575° C. for fresh and thermally aged samples at about 900° C. and about 1000° C., to compare OSM properties of the disclosed CuₓMn₃₋ₓO₄ spinel formulation employing variations of spinel composition, as follows:

The OSC test results for samples of Cu—Mn spinel prepared per EXAMPLE #1 with x=0.5 (non-stoichiometric structure of spinel), for fresh samples shows an oxygen delay time of about 45.67 seconds, and for hydrothermally aged samples at about 900° C. and about 1000° C. are about 40.95 seconds and about 16.98 seconds respectively. Comparison of test results of fresh and aged samples at 900° C. showing high OSC property and thermal stability of this sample, even for aged samples at 1000° C. with 16.98 seconds shows an acceptable level of OSC, which shows disclosed OSM has great stability.

The OSC test results for samples of Cu—Mn spinel prepared per EXAMPLE #2, for fresh samples with x=0.75 (non-stoichiometric structure of spinel), shows the resulting oxygen delay time of about 52.35 seconds, for hydrothermally aged samples at about 900° C. and about 1000° C. is about 37.81 seconds and about 16.98 seconds respectively. Comparison of test results for fresh samples with x=0.75, shows significant increase of oxygen delay time and thermal stability. For aged samples at about 900° C. may be observed a slight reduction of oxygen delay time, and for aged samples at 1000° C. shows exactly the same level of thermal stability shown as samples with x=0.5.

Test results for samples of Cu—Mn spinel prepared per EXAMPLE #3 with x=1.0 (stoichiometric structure of spinel), for fresh samples shows an optimized oxygen delay time of about 62.99 seconds, for aged samples at about 900° C. and about 1000° C. are about 45.54 seconds and about 11.18 seconds respectively. Test comparison of variations of Cu—Mn spinel ratio for fresh and aged samples at 900° C. with x=1.0 exhibit significant high OSC properties and substantial increase of oxygen delay time of about 62.99 seconds for fresh sample compare to spinel composition with x=0.5 and x=0.75. However, hydrothermal aged samples at about 1000° C. with Cu—Mn ratio closer to x=1.0 shows lower oxygen storage capacity, and therefore lower stability.

The resulting optimized oxygen delay time properties obtained from fresh samples of disclosed OSM without rare metals, may be indicative of dependency of OSC properties and thermal stability of CuₓMn₃₋ₓO₄ to the spinel structure and composition, providing an OSM without rare metals, which may include optimum composition of Cu—Mn spinel for optimized OSC and thermal stability.

FIG. 5 illustrates test results CO delay time 500 for variation of CO delay time for disclosed OSM samples without rare metals prepared per Example #1 to Example #3 with different spinel compositions, performing an isothermal oscillating OSC test at temperature of about 575° C. Aged samples have been prepared by hydrothermal aging with 10% steam at about 900° C. for about 4 hours, and by hydrothermal aging with 10% steam at about 1000° C. for about 4 hours.

In FIG. 5, each of the data points represents variations of Cu and Mn ratios “x” of CuₓMn₃₋ₓO₄ spinel formulation without rare metals employing stoichiometric and non-stoichiometric spinel deposited on Nb₂O₅—ZrO₂ support oxide. Fresh and aged samples may be employed to measure the CO delay time in seconds according to temperature, including but not limited to fresh, and hydrothermally aged samples at 900° C., and at 1000° C. temperature. The data points are identify, as follows: For x=1.0 data point 502 (dot and dash lines), for x=0.75 data point 504 (dash lines), and for molar ratio x=0.5 data point 506 (solid lines). Each of the data points represents the measured CO delay time in seconds based on the OSC test performed at 575° C. for fresh and hydrothermally aged samples at about 900° C. and about 1000° C., to compare OSM properties of the disclosed CuₓMn₃₋ₓO₄ spinel formulation employing variations of molar ratio “x”, as follows:

The OSC test results for samples of Cu—Mn spinel prepared per EXAMPLE #1 with x=0.5 (non-stoichiometric spinel), for fresh samples shows CO delay time of about 44.55 seconds, and for hydrothermally aged samples at about 900° C. and about 1000° C. are about 42.45 seconds and about 20.73 seconds respectively. Comparison of test results of fresh and aged samples at 900° C. showing high OSC property and thermal stability of this sample, even for aged samples at 1000° C.

The OSC test results for samples of Cu—Mn spinel prepared per EXAMPLE #2 with x=0.75 (non-stoichiometric spinel), for fresh samples shows CO delay time of about 50.46 seconds, and for hydrothermally aged samples at about 900° C. and about 1000° C. is about 40.4 seconds and about 21.43 seconds respectively. Comparison of test results for fresh samples with x=0.75, shows increase of CO delay time and thermal stability. For aged samples at about 1000° C. may be observed improvement in level of thermal stability compare to spinel with composition ratio of x=0.5.

The OSC test results for samples of Cu—Mn spinel prepared per EXAMPLE #3 with molar ratio x=1.0 (stoichiometric spinel), for fresh samples shows an optimized CO delay time of about 64.45 seconds, and for hydrothermally aged samples at about 900° C. and about 1000° C. is about 51.05 seconds and about 15.06 seconds respectively. Test comparison of variations of Cu—Mn spinel molar ratio, may demonstrate that fresh and aged samples at 900° C. with molar ratio x=1.0 exhibit a significant high OSC properties, thermal stability and substantial increase of CO delay time of about 64.45 seconds and about 51.05 seconds respectively. However, aged samples at about 1000° C. with 15.6 seconds shows lower level of thermal stability compare to non-stoichiometric spinel with x=0.5 and 0.75.

Based on results of OSC isothermal oscillating test performed on fresh and hydrothermally aged samples, the disclosed OSM without rare metals with variations of Cu and Mn compositional ratio “x” of CuₓMn₃₋ₓO₄ spinel formulation employing stoichiometric and non-stoichiometric spinel deposited on Nb₂O₅—ZrO₂ support oxide, may be selected for a plurality of TWC applications. Fresh samples with stoichiometric spinel structure (x=1.0) exhibit the best performance and optimal OSC properties, however, non-stoichiometric spinel structure (x=0.75) may also show optimal stability of OSC property. Therefore, Cu_{0.75}Mn_{2.25}O₄ spinel formulation may be selected as substitutes for commercial PGM catalyst with OSM, given their improved thermal stability and OSC properties.

The disclosed OSM may include a chemical composition substantially free from rare metals, presenting a plurality of advantages over OSM traditionally used in catalyst systems, including but not limited to optimum oxygen storage capacity and thermal stability. The OSM efficiency may provide solutions for enhanced performance of TWC catalyst systems, employing Cu—Mn spinel as OSM without rare metals, and variations of Cu—Mn molar ratios, with Niobium-Zirconia support oxide for OSM applications,

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A catalyst component, comprising: at least one oxygen storage material having a general formula of CuₓMn₃₋ₓO₄.

2. The catalyst component of claim 1, wherein the catalyst component is substantially free of rare earth metals.

3. The catalyst component of claim 1, wherein the at least one oxygen storage material is spinel form.

4. The catalyst component of claim 1, further comprising at least one support oxide.

5. The catalyst component of claim 4, wherein the at least one support oxide comprises niobium-zirconia.

6. The catalyst component of claim 1, wherein the at least one oxygen storage material is aged at about 900° C.

7. The catalyst component of claim 1, wherein the at least one oxygen storage material is aged at about 1000° C.

8. The catalyst component of claim 1, wherein x is selected from the group consisting of 1 and 0.75.

9. The catalyst component of claim 1, wherein CO conversion that occurs under isothermal oscillating conditions.

10. The catalyst component of claim 1, wherein the O₂ delay time is greater than 40 seconds.

11. The catalyst component of claim 1, wherein the O₂ delay time is greater than 10 seconds.

12. The catalyst component of claim 1, wherein the CO delay time is greater than 40 seconds.

13. The catalyst component of claim 1, wherein the CO delay time is greater than 10 seconds.

14. The catalyst component of claim 1, wherein the at least one oxygen storage material is non-stoichiometric.

15. The catalyst component of claim 1, wherein the at least one oxygen storage material is non-stoichiometric.

16. A catalyst system, comprising:
a substrate;
an overcoat comprising at least one oxygen storage material substantially free of rare earth metals; and
wherein the at least one oxygen storage material comprises Cu—Mn spinel having a niobium-zirconia support oxide; and
wherein the Cu—Mn spinel has the general formula Cu_{0.75}Mn_{2.25}O₄.

17. The catalysts system of claim 16, wherein the at least one oxygen storage material is aged at about 900° C.

18. The catalysts system of claim 16, wherein the at least one oxygen storage material is aged at about 1000° C.

19. The catalysts system of claim 16, wherein CO conversion that occurs under isothermal oscillating conditions.

20. The catalysts system of claim 16, wherein the O₂ delay time is greater than 40 seconds.

21. The catalysts system of claim 16, wherein the O₂ delay time is greater than 10 seconds.

22. The catalysts system of claim 16, wherein the CO delay time is greater than 40 seconds.

23. The catalysts system of claim 16, wherein the CO delay time is greater than 10 seconds.
